(19) United States
(12) Patent Application Publication
(10) Pub. No.: US 2007/0022132 A1
(43) Pub. Date: Jan. 25, 2007

(54) System and method for design using component categorization

(75) Inventors: Wayne David Brandt, Morton, IL (US); Vernon Richard Smith, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/185,708

(22) Filed: Jul. 21, 2005

(51) Int. Cl. G06F 7/00

(52) U.S. Cl. 707/102

(57) ABSTRACT

A computer readable medium for use on a computer system configured to generate a model of a component system includes computer executable instructions for receiving an input corresponding to at least one desired function of the component system. The computer readable medium may also include computer executable instructions for identifying at least one software model including software code adapted to execute a sequence of instructions corresponding to the at least one desired function. The computer readable medium may further include computer executable instructions for retrieving the at least one software model. The computer readable medium may also include computer executable instructions for arranging the at least one software model in the model of the component system.

### TECHNICAL FIELD

This application relates generally to a software system and method and, more particularly, to a system and method for design using component categorization.

### BACKGROUND

Computer aided design (CAD) software packages are widely available in the various engineering fields for design and analysis purposes, including semiconductor device fabrication and testing for communication systems, structural design, load analysis, engine design and performance analysis for the automotive industry, and several other such design and analysis purposes known in the art. Traditionally, CAD software programs provide a software model catalog from which a software designer may select one or more data models, arrange a functional system of components using the data models within the CAD environment, and design and test the functionality of the system. In current CAD software packages, the available data models may be classified according to the physical characteristics of the components that the models represent. For example, the models may be classified according to part numbers, model numbers, component types, and/or physical parameter ranges.

More recently, since software design application are so widely used by product designers, equipment manufacturers have developed software model catalogs for many of popular CAD programs to encourage the use of specific proprietary models corresponding to parts offered for sale. However, unless a product designer knows precisely which software models may be used to perform a particular function of the product under design, the designer may be limited to trial and error design methods. These trial and error design methods are inefficient and time-consuming.

In an attempt to improve design efficiency, software systems have been developed that use predefined specifications to classify available data models. For example, U.S. Patent Publication Number US 2002/0147517 (the '517 publication) to Messler published on Oct. 10, 2002, describes a method for cataloging information available on the Internet, retrieving information from multiple databases, and performing calculations to arrive at a final design. Specifically, the '517 publication creates an Internet database for approved engineering URL links, indexes the database of URL links for product or component information retrieval, provides a user interface for inputting specifications and requirements for an engineering project, performs calculations to arrive at a final design, and inserts design data into a job folder checklist.

Although the method of the '517 publication may facilitate the design of an engineering project based upon predetermined specifications, it may still be inefficient. For example, the method of the '517 publication creates a database that searches Internet websites for product or component information. Due to the high volume of traffic and substantial amount of data on the Internet, this may add an undue amount of time to the design process.

In addition, while the method of the '517 publication may provide engineering project design capabilities, the design projects may be limited to pre-existing engineering design templates based upon “traditional” engineering disciplines (e.g. civil, electrical, mechanical). Should a product designer require a design based upon a system that is unconventional or otherwise not included in the existing project templates, the capabilities of the system for providing flexible design are substantially reduced. Furthermore, because the Internet provides the project design elements to the system of the '517 publication, only publicly available information that is published on the Internet is accessible. Additionally, proprietary and/or state of the art products or services may not be available via the Internet. This could result in functionally limited and/or outdated designs.

The present disclosure is directed to overcoming one or more of the problems described above.

### SUMMARY OF THE INVENTION

In accordance with one aspect, the present disclosure is directed toward a computer readable medium for use on a computer system configured to generate a model of a component system. The computer readable medium may include computer executable instructions for receiving an input corresponding to at least one desired function of the component system. The computer readable medium may also include computer executable instructions for identifying at least one software model including software code adapted to execute a sequence of instructions corresponding to the at least one desired function. The computer readable medium may further include computer executable instructions for retrieving the at least one software model. The computer readable medium may also include computer executable instructions for arranging the at least one software model in the model of the component system.

According to another aspect, the present disclosure is directed toward a method for designing a software representation of a component system. The method may include receiving an input corresponding to at least one desired function of the component system. The method may also include identifying at least one software model including software code adapted to execute a sequence of instructions corresponding to the at least one desired function. The method may further include retrieving the at least one software model. The method may also include arranging the at least one software model in the software representation of the component system.

In accordance with yet another aspect, the present disclosure is directed toward a computer system that may include a console and at least one input device operatively coupled to the console. The system may also include a central processing unit, in communication with the at least one input device, configured to receive an input corresponding to at least one desired function of the component system. The central processing unit of the system may also be configured to identify at least one software model including software code adapted to execute a sequence of instructions corresponding to the at least one desired function. The central processing unit of the system may further be configured to retrieve the at least one software model. The central processing unit of the system may further be configured to arrange the at least one software model in the model of the component system.

### BRIEF DESCRIPTION OF THE DRAWINGS

FIG. 1 is a diagrammatic illustration of an exemplary disclosed computer design system; and

FIG. 2 is a flowchart illustration of an exemplary disclosed method of operating the computer system of FIG. 1.

### DETAILED DESCRIPTION

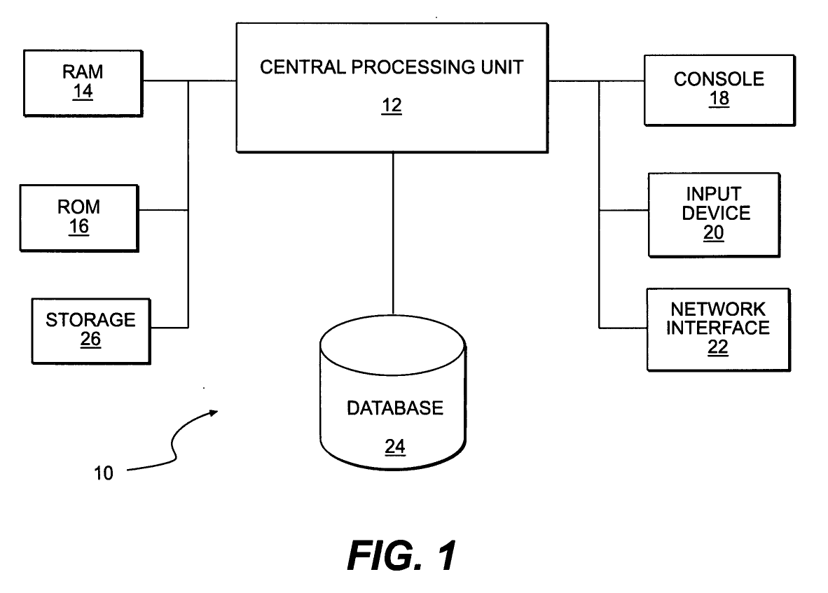

FIG. 1 illustrates a computer system 10 for designing a software representation of a component system. Computer system 10 may include a central processing unit (CPU) 12, a random access memory (RAM) 14, a read-only memory (ROM) 16, a console 18, an input device 20, a network interface 22, at least one database 24, and a storage device 26. It is contemplated that computer system 10 may include additional, fewer, and/or different components than what is listed above. It is understood that the type and number of listed devices are exemplary and not intended to be limiting.

CPU 12 may execute sequences of computer program instructions to perform various processes associated with designing a software representation of a component system, which may include one or more components operable to perform a particular function. The computer program instructions may be loaded into RAM 14 for execution by CPU 12 from ROM 16.

Storage device 26 may include any appropriate type of mass storage provided to store any type of information CPU 12 may need to perform the processes. For example, storage 26 may include one or more hard disk devices, optical disk devices, or other storage devices to provide storage space.

Computer system 10 may interface with a user via console 18, input device 20, and/or network interface 22. In particular, console 18 may provide a graphics user interface (GUI) to display information to users of computer system 10. Console 18 may be any appropriate type of computer display device or computer monitor. Input device 20 may be provided for users to input information into computer system 10. Input device 20 may include, for example, a keyboard, a mouse, optical or wireless computer input devices, or any other type of input device. Further, network interface 22 may provide communication connections such that computer system 10 may be accessed remotely through computer networks.

Database 24 may contain software model data and any information related to data under analysis by computer system 10. Database 24 may also include analysis tools for analyzing the information within database 24. CPU 12 may use database 24 to store and retrieve software models, to sort one or more software models based upon user-defined criteria, and/or access and classify data according to one or more categorization types.

Database 24 may include an access and/or data management software applications configured to store, access, sort, manage, and/or maintain data associated with computer system 10. Database 24 may include one or more software models adapted for use by one or more applications of computer system 10. Database 24 may be integral to computer system 10 or may be associated with a standalone system or application. Database 24 may include a commercially available database program, a custom software component system, a proprietary model library, a sortable data table, and/or any other access and/or data management system known in the art for storing and accessing data elements.

Software models may include executable software code for use by computer system 10 and may be configured to perform representative functions of a physical component of a component system when executed by CPU 12. For example, the one or more software models may include software code representative of various components of a component system. The models may represent physical dimensions and functional characteristics of components such as system controllers, sensors, meters, valve controllers, pressure cylinders, bearings, fasteners, motors, or any such component capable of performing a function in a system.

One or more software models from database 24 may be used by CPU 12 to design software representations of any of the components of a system. Furthermore, a plurality of software models may be arranged in a particular configuration to produce a software representation of a component system. For example, software models corresponding to a temperature sensor, a pressure sensor, an airflow sensor, and a fuel controller may be arranged to produce a control system for an engine. Several systems of components may be combined to design an entire equipment system made up of several sub-systems performing independent and/or related functions.

The software models may be classified within database 24 according to two criteria: a product type specification and an asset type specification. The software model classifications may be arranged within database 24 based upon one or more descriptions of the classification criteria. For example, the software models stored in database 24 may be classified according to descriptions of the product type specification and/or the asset type specification for a particular software model. When searched or sorted by CPU 12, the software models may be accessed based on the classification of the software models.

The product type specification of the one or more software models may include one or more descriptive categories of the representative component type such as, for example, pumps, motors, sensors, relays, engines, circuits, and/or any such general classifications used to identify a component type. The product type specification may be further defined by one or more physical parameters or specifications, which may be used to identify the particular component model type. These physical parameters or specification may include, for example, a bolt pattern of an assembly, a shaft diameter of a motor, a thread pattern for a fastener, or any other appropriate physical description of a particular component.

The product type specification may allow CPU 12 to access one or more software models stored in database 24 by searching for a list of models based upon the type of component desired for a system design. CPU 12 may search and arrange software models according to the physical criteria received by computer system 10 through one or more of console 18, input device 20, and network interface 22. For example, a design project may require a particular product number or product type (e.g. motor, pump, sensor, etc.) CPU 12 may perform a search of database 24 to arrange the software models according to the physical or product type specification requirements of the design project. For example, if computer system 10 receives an input that a software representation of a component system includes a temperature sensor, with a range of predetermined physical attributes such as size, bolt pattern, or housing material, computer system 10 may search for a model of a sensor with the product type specification associated with the attributes. CPU 12 may retrieve one or more temperature sensor models that meet the desired criteria.

Alternatively, software models may be classified according to the function of the component, referred to in this disclosure as the asset type specification of the representative component. The asset type specification may relate to one or more functions of the components such as, for example, monitoring, pumping, lifting, turning, moving, transmitting, receiving, or any other such function that a component or system of components may perform. The asset type specification may be further defined by one or more functional descriptions or parameters, which may be used to identify the component function. These functional descriptions may include, for example, a voltage level, a horsepower output, a temperature range, a maximum pressure output, or any other such functional characteristic of the software model.

The asset type specification may allow CPU 12 to access one or more software models stored in database 24 by searching for a list of models based upon the function that a desired component or system may perform. CPU 12 may perform a search of database 24 and arrange software models according to the asset type specification of the design project. Specifically, a design project may require one or more models representative of components that may be arranged and/or configured to perform a particular function (e.g. movement of a frame member, monitoring the temperature of a coolant temperature, etc.) CPU 12 may search and arrange software models stored in database 24 according to the asset type specification requirements of a design project. For example, computer system 10 may receive an input requesting a software representation of an actuator to move a frame member at a certain speed, range of motion, and/or force. CPU 12 may search for a model representative of one or more components with the asset type specification associated with one or more sub-functions of actuator movement. CPU 12 may retrieve one or more models that meet the requested functional criteria.

Database 24 may be configured to store, arrange, sort, select, display, and/or transmit one or more software models, based upon user-defined input to computer system 10. For example, CPU 12 of computer system 10 may receive a desired characteristic of a component from a user. CPU 12 may provide information to database 24 to arrange, sort, select, display, and provide one or more software models stored within database 24 to CPU 12 for further use within a design software application of computer system 10.

### INDUSTRIAL APPLICABILITY

The disclosed software design system may facilitate the design of a component system through a functional design approach. In particular, the software design system may be operable to receive a desired function to be performed by a component system, to identify and retrieve one or more software models operable to perform the function, and to arrange the one or more software models in a system capable of executing the desired function. The operation of software design system 10 will now be described in detail.

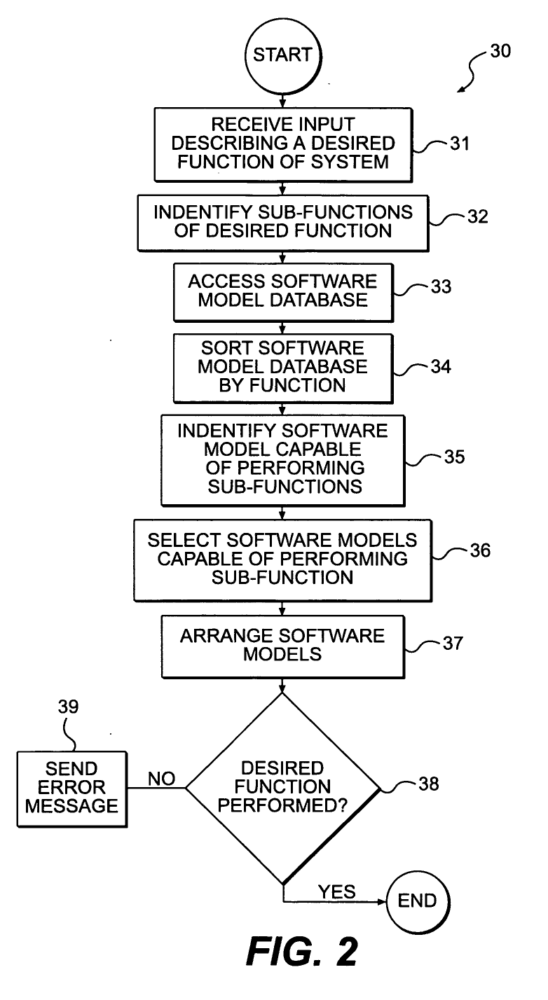

As illustrated in flowchart 30 of FIG. 2, a design project may be initiated using software design system 10 when one or more inputs corresponding to a desired function of a component system is received (Step 31). Computer system 10 may receive the input corresponding to the desired function from one or more of the console 18, the input device 20, or the network interface 22. For example, computer system 10 may receive an input corresponding to a desired temperature monitoring function, which may include the sub-functions of receiving a query for sensing a temperature, sensing the temperature, and transmitting the sensed temperature data.

In addition, interactions between the sub-functions may be identified from the received input (Step 32) explaining the manner in which the sub-functions interact to perform the desired function. For example, for a temperature monitoring function, a receive sub-function may provide a trigger for a sense sub-function, which, when completed, may trigger a transmit sub-function which sends data acquired during the sense function. A user defined flowchart or block diagram of the desired function, which may contain functional information that can be identified by computer system 10, may define the interactions of the sub-functions. Once identified, the functions and sub-functions may provide operational parameters for the software design. For example, computer system 10 may receive one or more sub-functions to perform the desired function and/or one or more interactions between the sub-functions of a system. As in the above example, computer system 10 may receive an input corresponding to a monitoring function. The monitoring function may include one or more sub-functions such as sensing, receiving, and/or transmitting. Furthermore, computer system 10 may receive inputs corresponding to the interactions between the sub-functions. For a temperature monitoring system, the interactions may include details such as, for example, a receive sub-function may occur substantially before and provide a trigger for a sense sub-function, and the transmit function may occur in response to a recognition of data from the sense function. This interaction may be received in the form of a flow diagram or functional design diagram, which may be input by a user of computer system 10.

Once the necessary definitions of the function and sub-functions of the software design have been identified, CPU 12 may access database 24 (Step 33) to search for suitable software models to perform the desired function. For example, CPU 12 may have access to database 24 in order to search and sort the software models stored within database 24 for use in a software design environment.

The access provided to database 24 may allow CPU 12 to sort database 24 (Step 34) and identify software models (Step 35) according to the received functional inputs of computer system 10. For example, CPU 12 may sort database 24 by performing a product type specification search and/or an asset type specification search of database 24. CPU 12 may sort database 24 according to the ability of each of the modeled components to perform one or more sub-functions of the desired function (e.g. according to the asset type specification of software models). In response to the sorting, one or more software models representative of components that can perform the desired functions may be identified by CPU 12. For example, CPU 12 may sort software model database according to which software models may be operable to perform the sense sub-function (and any descriptions of the sense sub-function such as temperature range) of the monitoring function. CPU 12 may subsequently identify one or more software models that may be operable to perform the sense sub-function of the monitoring function, for use in the design of the component system.

In order to identify suitable software models, CPU 12 may be configured to perform a data search of database 24. For example, CPU 12 may receive the functional inputs and perform a search of the software models within database 24. From the example above, CPU 12 may identify one or more software models associated with the sub-functions of the monitoring function, based upon the search results. For example, one or more communication circuit models may be associated with the transmit and/or receive sub-functions and one or more data sensor models may be associated with the sense sub-function. Computer system 10 may display the results to the user for further selection of desired components and/or functionality.

Upon identifying software models operable to perform sub-functions of the desired function, software models may be selected for use in the component system under design (Step 36). The selection step may be performed by CPU 12 automatically or may be manually performed by a user of software design system 10. In one example, the software models operable to perform a sense sub-function may be selected for use in the software design environment. Similarly, the software models operable to perform transmit and receive sub-functions may be selected for use in the software design environment.

Once CPU 12 has selected software models, the component system may be configured by arranging the selected software models within computer system 10 (Step 37). For example, software models operable to perform the sense sub-function may be arranged with one or more software models to perform the transmit and receive sub-functions to create a component system (as well as a new software model) operable to perform the desired monitoring function.

CPU 12 may receive one or more software models from database 24 and automatically arrange and/or configure the software models to execute the sequence of instructions corresponding to the desired function. For example, a communication circuit model, selected by CPU 12 to perform a transmit and receive sub-function, may be coupled to the temperature sensor model. The models may be arranged such that the sensor model may perform a sense function upon receipt of a query signal by the one or more communication circuit models, which may be configured to transmit the data from the sense function.

Upon creation of the software representation of the component system, CPU 12 may verify the conformance of the component system to the desired function input by the user. For example, the software representation of the component system may be analyzed by CPU 12 to ensure that the assembled component system model performs the functions and sub-functions appropriately (Step 38). If the component system performs as desired, the component system model may be stored within database 24 as a new software model. Alternatively, should the component system model not function appropriately, or not perform the desired function, then an error message may be sent to console 18 (Step 39).

CPU 12 may be configured to classify and store additional software models within database 24. For example, once a component system model has been assembled and/or arranged, CPU 12 may classify the new software model according to one or more of the product type specification and the asset type specification of the new software model. CPU 12 may then store the new software model within database 24 for future access.

Software design system 10 may improve the efficiency of designing component systems. For example, because all of the data elements may be pre-defined and readily accessible to software design system 10, the design process may be performed substantially within a single design and access environment without the need for external data searching or Internet-based data acquisition. Once the desired functional parameters have been received by software design system 10, computer system 10 may operate automatically to design the component system. This may improve efficiency of the design process and ensure that software design system 20 may operate independent of other applications or programs.

Furthermore, because software design system 10 may include a functional software design approach, software design system 10 may improve the flexibility and versatility of design tools. For example, because software design system 10 can create and/or assemble software models based upon functional approaches along with or as an alternative to physical approaches, software design system 10 may be configured to create component system models based upon a variety of software models, not available to a system focused on physical models. Because functional and physical characteristics may be used as the basis of component system design, software design system 10 may provide a more flexible design approach than existing design systems.

Software design system 10 may reduce the time and knowledge level required in product design processes. For example, because database 24 may be structured and defined based upon functional descriptions in addition to product descriptions, the need for knowledge of particular component models or component product catalogs may be significantly reduced. Software design system 10 may permit a user to design a system based only on knowledge of desired functions of the component system, rather than requiring a user to know precisely which components can perform the functions. This functional design approach can reduce the time a user must spend doing product research, which may substantially reduce the time required for overall system design.

It will be apparent to those skilled in the art that various modifications and variations can be made to the disclosed software design system without departing from the scope of the invention. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A computer readable medium for use on a computer system configured to generate a model of a component system, the computer readable medium including computer executable instructions for:
receiving an input corresponding to at least one desired function of the component system;
identifying at least one software model including software code adapted to execute a sequence of instructions corresponding to the at least one desired function;
retrieving the at least one software model; and
arranging the at least one software model in the model of the component system.

2. The computer readable medium of claim 1, wherein the at least one desired function includes a first sub-function, and the computer readable medium further includes instructions for:
receiving an input corresponding to a second sub-function;
identifying a second software model including software code adapted to execute a sequence of instructions corresponding to the second sub-function;
retrieving the second software model;
receiving an input corresponding to an interaction between the first and second sub-functions; and
arranging the at least one software model and the second software model in the model of the component system based on the interaction between the first and second sub-functions.

3. The computer readable medium of claim 2, further including instructions for storing the arranged software models as a new software model according to the interaction between the first and second sub-functions.

4. The computer readable medium of claim 1, wherein the at least one software model is identified according to at least one of a product type specification and an asset type specification.

5. The computer readable medium of claim 4, wherein the product type specification describes at least one physical characteristic of each of the at least one software models.

6. The computer readable medium of claim 4, wherein the asset type specification represents at least one functional characteristic associated with the plurality of software models.

7. The computer readable medium of claim 1, wherein identifying the at least one software model includes:
sorting a plurality of software models in a database according to a product type specification and an asset type specification; and
selecting the at least one software models from the sorted database.

8. A method for designing a software representation of a component system, the method comprising:
receiving an input corresponding to at least one desired function of the component system;
identifying at least one software model including software code adapted to execute a sequence of instructions corresponding to the at least one desired function;
retrieving the at least one software model; and
arranging the at least one software model in the software representation of the component system.

9. The method of claim 8, wherein the at least one desired function includes a first sub-function, and the method further includes:
receiving an input corresponding to a second sub-function;
identifying a second software model including software code adapted to execute a sequence of instructions corresponding to the second sub-function;
retrieving the second software model;
receiving an input corresponding to an interaction between the first and second sub-functions; and
arranging the at least one software model and the second software model to execute a sequence of instructions for the software representation of the component system based on the interaction between the first and second sub-functions.

10. The method of claim 9, further including storing the arranged software models as a new software model according to the interaction between the first and second sub-functions.

11. The method of claim 8, further including identifying the at least one software model according to at least one of a product type specification and an asset type specification.

12. The method of claim 8, wherein identifying the at least one software model includes:
sorting a database including a plurality of software models according to at least one of a product type specification and an asset type specification for the plurality of software models;
selecting the at least one software model from the sorted database.

13. The method of claim 11, wherein the product type specification describes at least one physical characteristic associated with the plurality of software models.

14. The method of claim 11, wherein the asset type specification describes at least one functional characteristic associated with the plurality of software models.

15. The method of claim 8, further including:
classifying the software representation of the component system according to the desired function corresponding to the sequence of instructions; and
storing the software representation of the component system.

16. A computer system, comprising:
a console;
at least one input device operatively coupled to the console; and
a central processing unit, in communication with the at least one input device, configured to:
receive an input corresponding to at least one desired function of a component system;
identify at least one software model including software code adapted to execute a sequence of instructions corresponding to the at least one desired function;
retrieve the at least one software model; and
arrange the at least one software model in the model of the component system.

17. The computer system of claim 16, wherein the at least one desired function includes a first sub-function, and central processing unit is further configured to:
receive an input corresponding to a second sub-function;
identify a second software model including software code adapted to execute a sequence of instructions corresponding to the second sub-function;
retrieve the second software model;
receive an input corresponding to an interaction between the first and second sub-functions; and
arrange the at least one software model and the second software model in the model of the component system based on the interaction between the first and second sub-functions.

18. The computer system of claim 17, wherein the central processing unit is further configured to store the arranged software models as a new software model according to the interaction between the first and second sub-functions.

19. The computer system of claim 16, wherein the at least one software model is identified according to at least one of a product type specification and an asset type specification.

20. The computer system of claim 19, wherein the product type specification describes at least one physical characteristic of each of the at least one software models.

21. The computer system of claim 19, wherein the asset type specification represents at least one functional characteristic associated with the plurality of software models.

22. The computer system of claim 16, wherein identifying the at least one software model includes:
sorting a plurality of software models in a database according to a product type specification and an asset type specification; and
selecting the at least one software models from the sorted database.
